(19) United States
(12) Patent Application Publication
(10) Pub. No.: US 2020/0334356 A1
(43) Pub. Date: Oct. 22, 2020

(54) APPARATUS AND METHOD FOR MONITORING USE HISTORY

(71) Applicant: Terrelle E. Thompson, Long Beach, CA (US)

(72) Inventor: Terrelle E. Thompson, Long Beach, CA (US)

(21) Appl. No.: 16/917,300

(22) Filed: Jun. 30, 2020

(51) Int. Cl. G06F 21/55

(52) U.S. Cl. CPC G06F 21/554; G06F 2221/2111; G06F 21/552

(57) ABSTRACT

A system and method for monitoring use history of a secured electronic device is provided. One embodiment monitors operation of the secured electronic device, compares the monitored operation with a plurality of predefined trigger event activities, generates a trigger in response to the monitored operation matching one of the predefined trigger event activities, acquiring at least one image that includes an image of the person using the secured electronic device during the occurrence of the trigger event activity, acquiring supplemental information comprising at least information that identifies the secured electronic device and the time of occurrence of the operation that matches the predefined trigger event activity, associates the at least one image and the supplemental information, and communicates the at least one image and the supplemental information from the secured electronic device onto a communication network for storage in a data storage system.

### BACKGROUND OF THE INVENTION

Electronic devices are preferably used by an owner or another authorized person (using the electronic device with the owner's permission). However, from time to time, the electronic device may be in the possession of an unauthorized user. The unauthorized user may use, or attempt to use, the electronic device without the owner's permission. For example, a smart phone or the like that belongs to the owner might come into possession of another party (the unauthorized user) without the owner's permission. The unauthorized user may place a telephone call to another party using the smart phone, may access content using the smart phone, and/or may purchase a product and/or service through an internet site that has been accessed using the smart phone.

At most, activity logs and the like can be used to determine past operations performed by an electronic device. For example, a “recent calls” list presented on a smart phone display will indicate previous telephonic calls (when and to whom the call was made to or received from) made using that smart phone. A browser history may be used to determine the Internet browsing history performed by the electronic device, such as a lap top computer, desktop computer, personal device assistant (PDA), notebook, or the like. Such browsing history would indicate the various websites that have been accessed using the electronic device (indicating the date and/or time of the web site access).

Some applications maintain a listing of recently accessed documents, files, images, or the like. For example, a word processing application maintains a type of “history” to facilitate easy user access to recently used documents. An image file viewer application may maintain a similar type of access history. Here, the owner of the electronic device can open the applications to determine what documents, files, images or the like have been recently accessed. However, there is no practical way to identify an unauthorized user from this information.

In many situations, the use of the electronic device is not trackable. For instance, some applications do not maintain any type of history about the use of that application. Routine functions, such as power on, power off, or the like simply do not result in any type of history that can be later accessed by the owner.

As yet another example, the electronic device may be password secured or may be otherwise protected by security measures such as biometric sensing devices. The unauthorized user, when in possession of the electronic device, may attempt to use the electronic device. However, the unauthorized user would fail in their attempt to use the electronic device because of the security measures. Here, since there would be no activity log indicating past electronic device use (since the unauthorized user was unable to use the electronic device because of the security), the owner would not be able to ascertain that a thwarted use attempt has been prevented by the security measures. And, there would certainly be no way that the owner could determine the identity of the unauthorized user in these situations.

Accordingly, in the arts of electronic device security, there is a need in the arts for an improved methods, apparatus, and systems for monitoring use history of an electronic device to determine the identity of an unauthorized user who has used, or has attempted to use, the electronic device.

### SUMMARY OF THE INVENTION

Embodiments of the electronic device use history system provide a system and method for monitoring use history of a secured electronic device. One embodiment monitors operation of the secured electronic device, compares the monitored operation with a plurality of predefined trigger event activities, generates a trigger in response to the monitored operation matching one of the predefined trigger event activities, acquiring at least one image that includes an image of the person using the secured electronic device during the occurrence of the trigger event activity, acquiring supplemental information comprising at least information that identifies the secured electronic device and the time of occurrence of the operation that matches the predefined trigger event activity, associates the at least one image and the supplemental information, and communicates the at least one image and the supplemental information from the secured electronic device onto a communication network for storage in a data storage system.

### BRIEF DESCRIPTION OF THE DRAWINGS

The components in the drawings are not necessarily to scale relative to each other. Like reference numerals designate corresponding parts throughout the several views.

FIG. 1 is a block diagram of an electronic device use history system.

FIG. 2 is a block diagram of selected components of a secured electronic device.

FIG. 3 is a block diagram of the information management and user interface system.

### DETAILED DESCRIPTION

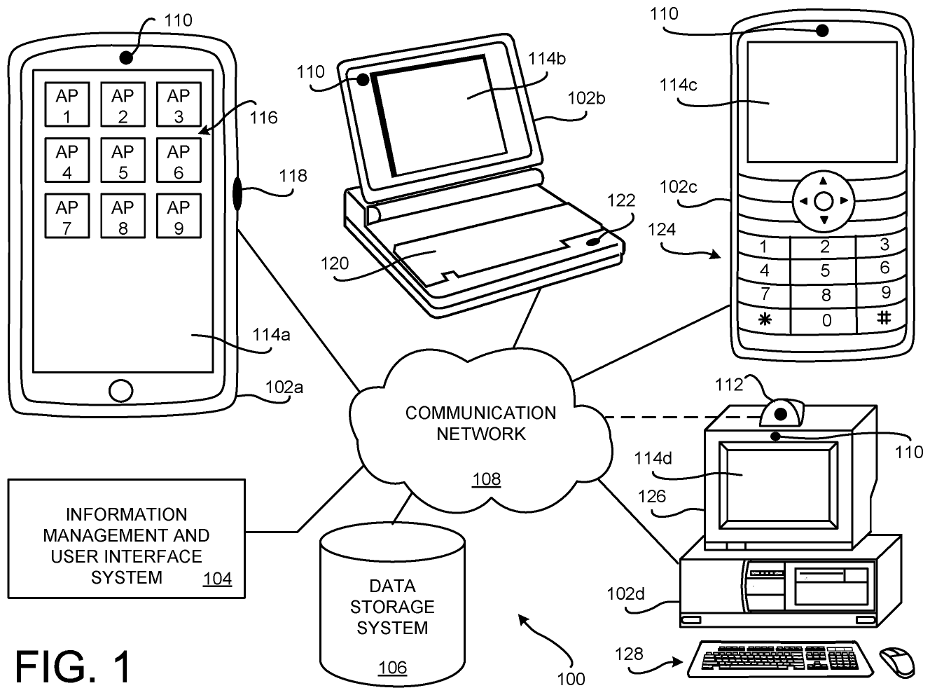

FIG. 1 is a block diagram of an electronic device use history system 100. Embodiments of the electronic device use history system 100 comprise one or more secured electronic devices 102a-102d (generically referred herein using reference numeral 102), an information management and user interface system 104, and data storage system 106. The secured electronic devices 102, the information management and user interface system 104, and the data storage system 106 are communicatively coupled to each other via a communication network 108.

The disclosed systems and methods for securing an electronic device 102 using the electronic device use history system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for securing an electronic device 102 using the electronic device use history system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device is communicatively connected to another electronic device, either wirelessly or with a wire based connector, whether directly or indirectly through a communication network 108.

Returning to FIG. 1, the example secured electronic devices 102 each have an integrated image capture device 110 (a camera) and/or are communicatively coupled to an external image capture device 112 that is optionally positioned and oriented so as to be operable to capture an image during a use of, or an attempted use of, the secured electronic device 102. In response to the occurrence of a trigger event, the electronic device use history system 100 causes the image capture device 110 to acquire an image. Presumably, the person using or attempting to use the secured electronic device 102 will be in the field of view of the image capture device 110 such that the acquired camera image includes an image of the person using, or attempting to use, the secured electronic device 102.

Exemplary secured electronic devices 102 include a smart phone 102a, a lap top computer 102b, a cellular phone or personal device assistant 102c, and a personal computer 102d (PC 102d). These non-limiting exemplary secured electronic devices 102 include in integrated display and/or are communicatively coupled to an external display, generically referred to herein as a display 114. Any electronic device now known or later developed that is able to control an image capture device 110 may be provisioned with an embodiment of the electronic device use history system 100.

The non-limiting example smart phone 102a includes a touch sensitive display 114a. Here, the image capture device 110 is collocated with the display 114a on the same surface of the secured electronic device 102a. This inward facing image capture device 102a is used to acquire or capture images of the person using, or attempting to use, the secured electronic device 102a.

To conceptually describe operation of this embodiment, a plurality of software application icons 116 are conceptually illustrated as being presented on a touch sensitive display 114a. One skilled in the art appreciate that the user begins operation of an application by touching the displayed application icon 116 that corresponds to the application of interest. In response to the user touching the displayed application icon 116, the display on the touchscreen display 114a transitions to present a display of the now running application of interest. The user is then able to navigate about the displayed application of interest to perform various tasks that are provided by that application. Further, one skilled in the arts appreciates that prior to use, the smart phone 102a is likely to be in a sleep state where the touch sensitive display 114a is in an off condition (the display 114a is typically black). When the user presses one of the controllers 118 on the surface of the smart phone 102a, touches the touch sensitive display 114a, and/or moves the smart phone 102a, the touch sensitive display 114a is turned on and an initial screen image is presented on the touch sensitive display 114a. When the user swipes on the touch sensitive display 114a (drags one or more of their fingers over the surface of the touch sensitive display 114a), then the smart phone 102a may operate to present the plurality of displayed application icons 116 on the touch sensitive display 114a or transition to another display screen.

The non-limiting example laptop computer 102b includes a keyboard 120, a power on/off switch 122, and a display 114b. When the user initially opens the laptop computer 102b, the display 114b is initially in an off condition (the display 114b is typically black) because the laptop computer 102b is typically in a powered down state or is in a sleep state before use. When the user actuates the power on/off switch 122, the laptop computer 102b becomes active and then presents an initial screen image and/or a screen saver image on the display 114b. Typically, one or more application icons (not shown) are indicated on the presented initial screen image. The user operates the laptop computer keyboard 120 or another user interface device (not shown) to cause the laptop computer 102b to begin execution of a particular application, program, and/or software of interest. In some laptop computers 102b, the display 114b is also a touch sensitive display that is operable to interact with the user.

The non-limiting example cellular phone or personal device assistant 102c includes a series of controllers 124 on the surface that the user may actuate to perform a desired operation. The cellular phone or personal device assistant 102c may include an optional display 114c. In some cellular phones or personal device assistants 102c, the display 114c may be limited to presenting textual information only. Other cellular phones or personal device assistants 102c may have a high resolution display 114c that may even be touch sensitive.

The non-limiting example personal computer 102d may be communicatively coupled to a display system 126 with a display 114d and an integrated image capture device 110. The personal computer 102d is also typically communicatively coupled to one or more user interface devices 128, such as a keyboard, a mouse or other user input device. The user interface devices 128 communicate electronic information signals that control operation of the personal computer 102d.

In some applications, the personal computer 102d may be optionally communicatively coupled to the external image capture device 112. Here, the personal computer 102d would control operation of the remote image capture device 112 and/or the integrated image capture device 110.

Other electronic devices and/or mechanical devices may be secured by embodiments of the electronic device use history system 100. In practice, such devices may be configured to generate and communicate a trigger signal that causes an image capture device 114 to capture an image, presumably that includes an image of the person operating, or attempting to operate, the electronic or mechanical device. For example, an automobile, watercraft, aircraft, or other vehicle may be provisioned with an embodiment of the electronic device use history system 100. Home appliances, book readers, and/or other devices associated with the Internet of things may be provisioned with an embodiment of the electronic device use history system 100. Such embodiments may control an integrated image capture device 110 and/or a remote image capture device 112. A processor residing in the electronic device and/or mechanical device may be configured to sense a trigger event, and then generate and communicate a trigger signal to cause an image capture to capture an image (acquire image data). In other embodiments, a mechanical device may be used to mechanically sense operation of the device, and then to cause the integrated image capture device 110 and/or the remote image capture device 112 to capture the image.

The information management and user interface system 104 manages presentation of images and/or supplemental information that has been acquired by a particular one of the secured electronic devices 102. Here, the authorized user of a secured electronic device 102 may, at some later point in time, review the images and/or supplemental information that has been acquired by their secured electronic device 102. The user then interfaces with the information management and user interface system 104 by communicating a user request for information. The user request may specify a time or time period of interest.

Also, the user request will indicate the identity of the particular secured electronic device 102 of interest. If the user is inquiring from the secured electronic device 102 of interest, then the user request can automatically include the identifying information of the secured electronic device 102. Alternatively, or additionally, the user may specify the secured electronic device 102 of interest.

In response to the user request, the information management and user interface system 104 accesses the stored previously acquired image and/or supplemental information that has been acquired by that user's secured electronic device 102. If the user request includes a time or time period, images and/or supplemental information acquired at that user specified time or time period is accessed. Then, the retrieved images and/or supplemental information are communicated to the user's secured electronic device 102 and/or to another electronic device that is being used by the user. In practice, the image and/or supplemental information can then be retrieved from the data storage system 106 and be communicated to the user's smart phone 102a for presentation on their smart phone 102a at a later time and/or a later date. Alternatively, or additionally, the image and/or supplemental information can be retrieved from the data storage system 106 and be communicated to the user's laptop computer 102b, cellular phone or personal device assistant 102c, personal computer 102d, and/or another electronic device for presentation

For example, the smart phone 102a may have captured one or more images by operating the image capture device 110, and/or may have acquired supplemental information at the time of image acquisition, in response to a trigger event. The acquired images and/or supplemental information is then automatically communicated out to the communication network 108 for storage into the data storage system 106. Preferably, the images and/or supplemental information are acquired and stored discreetly and automatically so that the person using the secured electronic device 102 is not aware of the acquisition of the images and/or supplemental information.

For example, during normal operation, some embodiments of a secured electronic device 102 are configured to emit an audible sound that emulates the shutter closing of a physical camera. For example, the smart phone 102a typically emits this shutter closing sound when the user takes a photograph using their smart phone 102a. In such embodiments, the emulating sound of the shutter closing in not emitted when an image is captured in response to a trigger event activity. Accordingly, the person using the secured electronic device 102 would not become aware of the image capture

Further, the person using the secured electronic device 102 is not able to prevent the acquisition of images and/or supplemental information when a trigger event occurs. Preferably, the software installed on the secured electronic device 102 is secured so that a person cannot tamper or remove the software.

In a preferred embodiment, the information management and user interface system 104 resides separately from the secured electronic device 102. The secured electronic device 102 communicates with the information management and user interface system 104 via the communication network 108. Alternatively, or additionally, the information management and user interface system 104 may reside as software in some secured electronic devices 102.

The communication network 108 is illustrated as a generic communication system. In one embodiment, the communication network 108 comprises a cellular telephone system, such as a radio frequency (RF) wireless system. Accordingly, the secured electronic device 102 and/or the information management and user interface system 104 includes a suitable transceiver. Alternatively, the communication network 108 may be a telephony system, the Internet, a Wi-fi system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. Additionally, embodiments of the secured electronic device 102 and/or the information management and user interface system 104 may be implemented to communicate using other types of communication technologies, such as but not limited to, digital subscriber loop (DSL), X.25, Internet Protocol (IP), Ethernet, Integrated Services Digital Network (ISDN) and asynchronous transfer mode (ATM). Also, embodiments of the secured electronic device 102 and/or the information management and user interface system 104 may be configured to communicate over combination systems having a plurality of segments which employ different formats for each segment that employ different technologies on each segment.

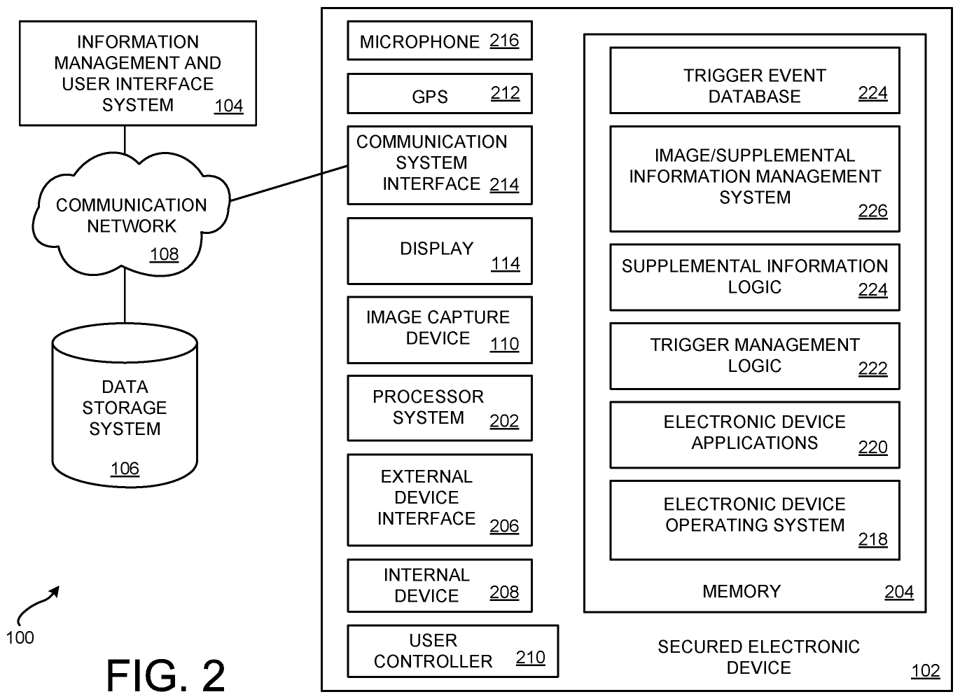

FIG. 2 is a block diagram of selected components of a secured electronic device 102. The secured electronic device 102 comprises an optional display 114, an optional image capture device 110, a processor system 202, a memory 204, an optional external device interface 206, one or more internal devices 208, one or more user controllers 210, an optional global positioning system (GPS) 212, a communication system interface 214, and an optional microphone 216. Memory 204 includes portions for storing the electronic device operating system 218, the electronic device applications 220, a trigger management logic 222, the supplemental information logic 224, the image and supplemental information management logic 226, and a trigger event database 228. In some embodiments, the electronic device operating system 218, the electronic device applications 220, the trigger management logic 222, the supplemental information logic 224, and/or the image/supplemental information management logic 226 may be integrated together, and/or may be integrated with other logic. In other embodiments, some or all of these memory and other data manipulation functions may be provided by using a remote server or other electronic devices suitably connected via the Internet or otherwise to a client device. Other secured electronic devices 102 may include some, or may omit some, of the above-described media processing components. Further, additional components not described herein may be included in alternative embodiments.

In practice, the electronic device operating system 218 is retrieved from memory 204 and is executed by the processor system 202, typically upon the startup or repowering of the secured electronic device 102. The electronic device operating system 218 manages the operation of the secured electronic device 102. The secured electronic device 102 typically has a plurality of electronic device applications 220 that perform specific functions and/or tasks. Such operating systems and applications are well known in the arts.

With the various embodiments of the electronic device use history system 100, a secured electronic device 102 acquires at least one image in response to the occurrence of a trigger event activity. In the various embodiments, the trigger management logic 222 monitors various activity that is occurring within the secured electronic device 102. Alternatively, or additionally, the trigger management logic 222 may monitor the various activities of other connected electronic devices, such as a keyboard, a mouse, a printer, a scanner or the like that are communicatively coupled to and/or that are controlled by the secured electronic device 102. Some of these activities have been predefined to correspond to a trigger event (interchangeably referred to herein as a trigger event activity). The trigger management logic 222 compares each monitored activity with the trigger events that are stored in the trigger event database 228. When one of the monitored activities matches one of the trigger events, then that activity results in generation of a trigger by the trigger management logic 222. The trigger in then communicated to the image capture device 110 and/or the external image capture device 112. In response to receiving the trigger, the image capture device 110 and/or the external image capture device 112 capture one or more still images or a video clip lasting for some predefined duration. The captured image information is intended to include an image of the face of the person currently using, or attempting to use, the secured electronic device 102.

In the various embodiments, the supplemental information logic 224 also receives the trigger, or is at least caused to acquire supplemental information in response to generation of the trigger. The supplemental information comprises various information of interest that is associated with the acquired image information. Non-limiting examples of supplemental information includes a time stamp (date and time) corresponding to the time that the image information was acquired, information that identifies the particular trigger event activity, location information provided by the GPS 212, audio information acquired by the microphone 216, device and/or owner identity information, etc. The device and/or owner identity information may include serial numbers of the particular secured electronic device 102, the name of the owner, and/or contact information for the owner such as a telephone number, an e-mail address, an account number, or the like. Any supplemental information of interest may be acquired for association with the image information in the various embodiments.

The supplemental information may also include a description of the trigger event activity that cause the trigger. For example, but not limited to, the opening or closing of a particular software program using the secured electronic device 102 may be used as supplemental information. As another non-limiting example, if an image was viewed, information identifying the viewed image and/or the viewed image itself may be acquired as supplemental information.

The image information acquired by the image capture device 110 and/or the external image capture device 112 is then processed by the image/supplemental information management logic 224. The image/supplemental information management logic 226 associates the supplemental information with the received image information. Then, the processed image information and supplemental information is automatically communicated out from the communication system interface 214 to the communication network 108 such that the image information and supplemental information is stored in the data storage system 106. This automatic communication of the images and/or supplemental information from the secured electronic device 102 prevents an unauthorized user from avoiding detection and/or identification.

The communication system interface 214 may communicatively couple the secured electronic device 102 to the communication network 108 using any suitable wire-based connector and/or a wireless connection, such as a Wi-fi signal, a blue tooth signal, or a cellular phone signal. Preferably, the secured electronic device 102 has already established a connection to the communication system 104. However, the image/supplemental information management logic 226 may cause the secured electronic device 102 to establish a communication link to the communication network 108 if the secured electronic device 102 is not already communicatively coupled to the communication network 108 at the time of the detection of the trigger event activity.

In the various embodiments, the trigger management logic 222, the supplemental information logic 224, and the image/supplemental information management logic 226 are running in the background while the secured electronic device 102 is performing other operations for the person who is using, or attempting to use, the secured electronic device 102. The systems 222, 224, 226 are preferably running under the execution of the processor system 202 whenever the secured electronic device 102 is powered. Accordingly, a person using the secured electronic device 102 will not be aware of the operation of the systems 222, 224, 226. The process of acquiring the images and/or supplemental information occurs automatically in response to the occurrence of a trigger event. Since the person operating the secured electronic device 102 is not aware of the operation of the systems 222, 224, 226, the person is not likely to take steps to attempt to thwart image capture of their face.

Alternatively, or additionally, the systems 222, 224, 226 may be running while the secured electronic device 102 is in an inactive state, sleep mode or the like. That is, the secured electronic device 102 may appear to the person as being in a shutdown mode or off state. In such embodiments, various activities of the person using the secured electronic device 102 may be detected and then be compared to a predefined trigger event activity. For example, the user controller 210 may be an on/off controller disposed on the surface of the secured electronic device 102. If a change of power state is predefined to be a trigger event activity, then the image information and supplemental information is acquired whenever the person turns on and/or turns off the secured electronic device 102.

As another non-limiting example, the internal device 208 may be a type of motion sensing device, such as a micro-electro mechanical system (MEMS) accelerometer or the like. Here, motion of the secured electronic device 102 would be predefined to be a trigger event activity. If the internal device 208 senses motion of the secured electronic device 102, preferably after the secured electronic device 102 has been motionless for some predefined threshold duration, then the sensed motion would cause generation of the trigger to acquire the image information and supplemental information. In some embodiments, image capture occurs after some predefined delay duration. Alternatively, or additionally, a series of images are captured over some predefined duration in response to sensing the motion of the secured electronic device 102. For example, the owner may have lost or misplaced their smart phone 102a. An unauthorized person may later find and pick up the smart phone 102a. The motion of the smart phone 102a would then cause capture of an image of that person.

Certain uses of other electronic devices that are communicatively coupled to the secured electronic device 102 may be predefined as a trigger event activity. For example, one or more user interface devices 128, such as a keyboard, a mouse or other user input device may be communicatively coupled to the PC 102d via the external device interface 206. Here, the external device interface 206 may use a wire-based and/or wireless connection to the user interface device. When the person uses, or attempts to use, the PC 102d, the use of the user interface device 128 may generate a trigger event so as to capture an image of the person.

A variety of operations performed by the secured electronic device 102 may be predefined as being a trigger event activity. With respect to the example smart phone 102a, the user swiping their finger across the touchscreen display 114a may be predefined as a trigger event activity. Turing on and/or turning off the smart phone 102a, touching or selecting an application icon 116 to open up an application of interest, accessing a remote web site, playing a game, purchasing a product, viewing content, browsing through photographs, or any of the many different operations that can be performed using a smartphone 102a may be predefined as a trigger event activity. (Such activities and/or operations may also be applicable to other types of secured electronic devices 102.)

With respect to the laptop 102b, the 102c and/or the PC 102d, any suitable operation that can be performed may be predefined as a trigger event activity. For instance, each time a browser accesses a different web site may be predefined to be a trigger event activity. Initially receiving user input from one or any of the user input devices 128, or saving data, may be predefined to be a trigger event activity. Conducting a transaction using the laptop 102b and/or the PC 102d may be predefined to be a trigger event activity. Making a phone call using the cellular phone or personal device assistant 102c, and/or opening email may be predefined to be a trigger event activity. One skilled in the arts appreciates that the various operations performed by a secured electronic device 102 that may be predefined to be a trigger event activity is limitless. All such operations, activities, or the like that are defined to be a trigger event activity are intended to be within the scope of this disclosure and are intended to be protected by the accompanying claims.

In a preferred embodiments, the electronic device use history system 100 is pre-installed into the secured electronic device 102 before being purchased by the owner. The electronic device use history system 100 may be pre-installed with other bloat ware. Alternatively, or additionally, the electronic device use history system 100 may be later installed into the secured electronic device 102 after the user comes into possession of their electronic device 102. The software to execute the electronic device use history system 100 may be delivered as an application (commonly referred to as an “App”) or may be downloaded as software from an internet site. The electronic device use history system 100 may be provided as part of a service, and/or may be acquired through purchase, licensing, leasing, or the like. All such forms of the electronic device use history system 100 installed into a secured electronic device 102 are intended to be within the scope of this disclosure and are intended to be protected by the accompanying claims

The activities and/or operations of the secured electronic device 102 that are to be predefined as a trigger event activity are stored in the trigger event database 224. In some embodiments, the predefined trigger event activities are stored into the trigger event database 224 when the electronic device use history system 100 is installed into the secured electronic device 102. The predefined trigger event activities may be specified for the particular type of secured electronic device 102. For instance, the predefined trigger event activities for the smart phone 102a may be different from the predefined trigger event activities for the laptop 1002b. Alternatively, some predefined trigger event activities may be the same or similar for all types of secured electronic devices 102. For example, powering on or shutting down an electronic device may be common to all of the various types of secured electronic devices 102.

During use of the secured electronic device 102, time of use may be defined as a trigger event activity. For example, every fifteen minutes of use of the secured electronic device 102 may be defined as a predefined trigger event activity such that a trigger is generated once every fifteen minutes. Any suitable time period or the like may be predefined as a trigger event activity.

Some embodiments of the electronic device use history system 100 permit the user (the owner or other authorized person) to specify a particular trigger event activity of interest for storage into the trigger event database 224. The user specified trigger event activity may then be saved into the trigger event database 224. A graphical user interface (GUI) may be presented on the display 114 to permit the user to specify a predefined trigger event activity. Similarly, some embodiments may permit the user to delete a selected predefined trigger event activity from the trigger event database 224. In such embodiments, a listing of saved predefined trigger event activities may be presented to the user on the display 114. The user may then navigate about the list to select and/or to delete a predefined trigger event activity.

Some embodiments may be configured to capture a single image in response to detecting a trigger event. Alternatively, a series of still images may be captured over some predefined duration. Further, capture of individual images in the series may be separated by some predefined duration. For example, but not limited to, a series of captured image each separated by one second may be captured over a one minute duration. Alternatively, a video clip over some predefined duration may be captured. When a plurality of still images or a video clip are captured in response to detecting a trigger event, the likelihood of obtaining a clear image of the person using the secured electronic device 102 is increased.

In some situations, the secured electronic device 102 may be communicatively coupled to one or more remote image capture devices 112. Here, in response to detection of a trigger event activity, the secured electronic device 102 may initiate image capture using the one or more remote image capture devices 112. For instance, a remote image capture device 112 may be located some distance away from the secured electronic device 102, such as on the other side of the room. The acquired image will include an image of the person using, or attempting to use, the secured electronic device 102 along with images of other objects and/or people in the field of view of the remote image capture device 112.

Additionally, or alternatively, the one or more remote image capture devices 112 can acquire supplemental information in the form of acquired images. For example, if the field of view of the remote image capture device 112 was directed to the outdoor driveway or walkway, the acquired supplemental image information would show images of various outdoor objects in the outdoor environment. To illustrate, an intruder may have entered into the residence of the user. If the intruder found the owner's smart phone 102a or tried to steal the PC 102d, and this activity was detected by the electronic device use history system 100, then an image of the driveway might include an image of the vehicle of the intruder and/or images of any accomplices.

Some embodiments may be configured to capture images using multiple image capture devices 110, 112. Capture of additional images may provide information about the environments in which the secured electronic device 102 was operating at the time of the occurrence of the trigger event activity. For example, many smart phones 102a have both an inward facing and an outward facing image capture device 110 (that faces outward in an opposing direction to the inward facing image capture device 110). The inward facing image capture device 110 would capture an image of the person using the secured electronic device 102. The outward facing image capture device 110 could be used to concurrently capture one or more images of the environment in front of the person during the occurrence of the trigger event activity.

In some embodiments, the supplemental information may include the GPS location information of the smart phone 102a. Here, the GPS 212 determines the current location of the smart phone 102a. For example, if the trigger event activity occurred on the PC 120d, the trigger could be communicated to the user's smart phone 102a. The current location of the smart phone 102a, determined by the GPS 212, would then be included as supplemental information. Here, if the user was not at home where their PC 102d is located, the GPS location of the smart phone 120a would inform the user of their location when the PC 102d was being used.

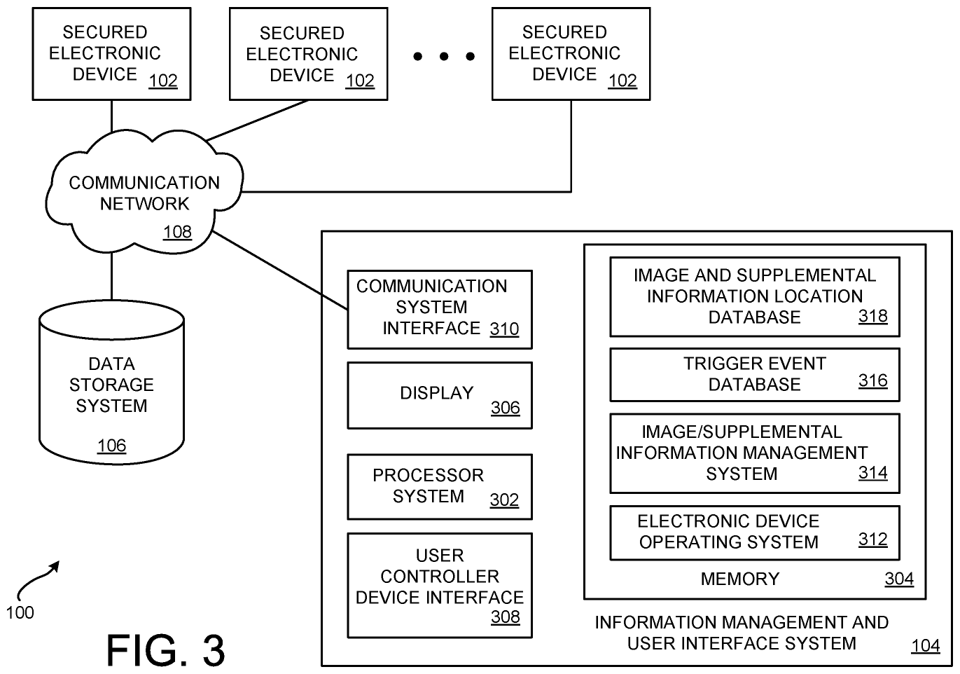

FIG. 3 is a block diagram of the information management and user interface system 104. The information management and user interface system 104 comprises a processor system 302, a memory 304, an optional display 306, an optional user controller interface 308, and a communication system interface 310. Memory 304 includes portions for storing the electronic device operating system 312, the image/supplemental information management system 314, an optional trigger event database 316, and an image and supplemental information location database 318. In some embodiments, the electronic device operating system 312 and/or the image/supplemental information management system 314 may be integrated together, and/or may be integrated with other logic. In other embodiments, some or all of these memory and other data manipulation functions may be provided by using a remote server or other electronic devices suitably connected via the Internet or otherwise to a client device. Other information management and user interface systems 104 may include some, or may omit some, of the above-described media processing components. Further, additional components not described herein may be included in alternative embodiments

The electronic device operating system 312 controls operation of the information management and user interface system 104 when executed by the processor system 302. When executed by the processor system 302, the image/supplemental information management system 314 performs a variety of functions pertaining to the management of images and/or supplemental information that has been acquired by one of the plurality of secured electronic devices 102. The optional trigger event database 316 may contain information about a plurality of trigger event activities. The image and supplemental information location database 318 stores location information that identifies the memory location where particular images and/or supplemental information have been stored in the data storage system 106.

The data storage system 106 may be any suitable data storage system. In some embodiments, the data storage system 106 and the information management and user interface system 104 are collocated in the same facility. Alternatively, or additionally, some or all of the data storage system 106 may be implemented in a distributed fashion. Such a distributed architecture for the data storage system 106 is often referred to as the “cloud” in the arts.

The communication system interface 310 may communicatively couple the information management and user interface system 104 to the communication network 108 using any suitable wire-based connector and/or a wireless connection. Accordingly, the electronic device use history system 100 may communicate with any of the secured electronic devices 102 and the data storage system 106.

In some embodiments, the electronic device use history system 100 may be manned by an operator. In such embodiments, the user controller device interface 308 may communicatively couple the information management and user interface system 104 to one or more user interface devices (not shown). The optional display 306 may present information regarding various operations being performed by the information management and user interface system 104. Alternatively, or additionally, particular selected images and/or supplemental information may be accessed from the data storage system 106 and then presented to the operator.

In an example embodiment, when a particular one of the secured electronic devices 102 detects a trigger event activity, the secured electronic device 102 acquires the images and/or supplemental information and communicates the information to the information management and user interface system 104, via the communication network 108. The information management and user interface system 104 may optionally process the received images and/or supplemental information into a discrete trigger event activity information package that is associated with the transmitting secured electronic device 102. Preferably, each trigger event activity information package is associated with the identity of the secured electronic device 102 and the time/date stamp corresponding to the time of acquisition of the images and/or supplemental information. The trigger event activity information package is then communicated to the data storage system 106 for storage. (Alternatively, each image and piece of supplemental information may be associated with the identity of the secured electronic device 102 and the time/date stamp.)

The image/supplemental information management system 314 may specify the storage location in the data storage system 106 when the trigger event activity information package is sent to the data storage system 106 for storage. Information identifying the storage location is then saved into the image and supplemental information location database 318. When the user request is received, the identity of the secured electronic device 102 and the time or time period of interest can be compared with the identity of secured electronic devices 102 and the associated time stamp. When a match is found, then the location of the stored images and/or supplemental information can be determined from the corresponding location information that is stored in the image and supplemental information location database 318. The image/supplemental information management system 314 may then access the stored images and/or supplemental information based on the determined location information, and then communicate the retrieved images and/or supplemental information to the user's secured electronic device 102 or another designated electronic device. Preferably, the user request indicates whether the retrieved images and/or supplemental information should be sent to the user's secured electronic device 102 or to a particular designated electronic device. For example, the images and/or supplemental information may have been acquired by the user's smart phone 102a. However, the user may wish to view the retrieved images and/or supplemental information using their PC 102d. Accordingly, the user request would include information identifying the smart phone 102a, a time or time period of interest, and information identifying the PC 102d that is to receive the retrieved images and/or supplemental information. Further, the user request may include information needed to establish communications between the PC 102c and the information management and user interface system 104, or between the PC 102d and the data storage system 106 in cases where the data storage system 106 send the retrieved images and/or supplemental information do the user's designated electronic device.

In some embodiments, a list of trigger event activities may be stored in the trigger event database 316. In some instances, the secured electronic device 102 may communicate with the information management and user interface system 104 with a request to receive a trigger event activity update that includes newly defined trigger event activities for that particular secured electronic device 102. Alternatively, or additionally, as a new trigger event activity or plurality of trigger event activities are defined, the information management and user interface system 104 may automatically transmit the new trigger event activity to those secured electronic devices 102 that could be configured to detect the new trigger event activity. Further, for each secured electronic device 102, a log of predefined trigger event activities may be saved into the trigger event database 316. From time to time, a list of currently saved trigger event activities stored in the trigger event database 224 of the secured electronic device 102 may be compared with the log of trigger event activities in the trigger event database 316 to detect possible tampering.

In some situations, a secured electronic device 102 may become lost or stolen. The user could then submit a request to the information management and user interface system 104. If any trigger event activities have occurred after the secured electronic device 102 was lost or stolen, the information management and user interface system 104 could access and send those images and/or supplemental information to the user. The information may assist the user in recovering their lost or stolen secured electronic device 102.

Additionally, or alternatively, the information management and user interface system 104 could access and send those images and/or supplemental information to the police or other authority. The thief may then be identified from the captured images. If GPS location is included in the supplemental information, then the stolen secured electronic device 102 may be more readily recovered.

It should be emphasized that the above-described embodiments of the electronic device use history system 100 are merely possible examples of implementations of the invention. Many variations and modifications may be made to the above-described embodiments. All such modifications and variations are intended to be included herein within the scope of this disclosure and protected by the following claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. An electronic device use history system, comprising:
a secured electronic device that acquires at least one image and supplemental information in response to detecting an occurrence of a trigger event activity,
wherein the at least one image includes an image of a person using the secured electronic device during the occurrence of the trigger event activity,
wherein the supplemental information includes a time that the at least one image was acquired and includes identification information that identifies the secured electronic device;
wherein the trigger event activity is one of a plurality of predefined operations that is performed by the secured electronic device, and
wherein the acquired image is communicated into a communication network in response to capturing the image by an image capture device;
an information management and user interface system that receives the at least one image and the supplemental information that has been communicated into the communication network, wherein the at least one image is associated with the secured electronic device that detected the trigger event activity; and
a data storage system that stores the at least one image and the supplemental information that has been communicated into the communication network.

2. The electronic device use history system of claim 1, wherein the secured electronic device is a first secured electronic device, and further comprising:
a second secured electronic device,
wherein in response to receiving a user request that includes the identification information that identifies the first secured electronic device, information identifying at least a time of interest, and information identifying the second secured electronic device as a recipient of the stored at least one image, the information management and user interface system retrieves the at least one image and the supplemental information from the data storage system and communicates the at least one image and the supplemental information to the second secured electronic device.

3. The electronic device use history system of claim 1, wherein the secured electronic device comprises:
a global positioning system (GPS) that determines a current location of the secured electronic device when the trigger event activity was detected.

4. The electronic device use history system of claim 1, wherein the secured electronic device comprises:
a display that presents content to the user of the secured electronic device; and
an inward facing image capture device that is collocated with the display on a same surface of the secured electronic device,
wherein in response to detecting the trigger event activity, the inward facing image capture device is operated to capture the at least one image showing the user.

5. The electronic device use history system of claim 4, wherein the at least one image captured by the inward facing image capture device is a first at least one image, and wherein the secured electronic device further comprises:
an outward facing image capture device that faces outward in an opposing direction to the inward facing image capture device,
wherein in response to detecting the trigger event activity, the outward facing image capture device is operated to capture a second at least one image showing an environment around the secured electronic device.

6. The electronic device use history system of claim 1, further comprising:
a remote image capture device that is controllably coupled to the secured electronic device,
wherein in response to detecting the trigger event activity by the secured electronic device, the remote image capture device is operated to capture the at least one first image.

7. A secured electronic device that acquires at least one image and supplemental information in response to detecting an occurrence of a trigger event activity, comprising:
a memory that stores trigger management logic, supplemental information acquisition logic, image and supplemental information management logic, and a trigger event database; and
a processor system executing the trigger management logic, the supplemental information acquisition logic, and the image and supplemental information management logic,
wherein the trigger management logic monitors an operation of the secured electronic device,
wherein the trigger management logic compares the monitored operation with a plurality of predefined trigger event activities stored in the trigger event database,
wherein in response to the monitored operation matching one of the predefined trigger event activities, the processor system generates a trigger that causes an image capture device to acquire the at least one image that includes an image of a person using the secured electronic device during the occurrence of the trigger event activity,
wherein the supplemental information acquisition logic acquires supplemental information comprising at least information that identifies the secured electronic device and the time of occurrence of the operation that matches the predefined trigger event activity,
wherein the image and supplemental information management logic associates the at least one image and the supplemental information, and
wherein the at least one image and the supplemental information is communicated onto a communication network for storage in a data storage system.

8. The secured electronic device of claim 7, further comprising:
a global positioning system (GPS) that determines a current location of the secured electronic device when the trigger event activity was detected,
wherein the supplemental information acquisition logic includes the current location in the supplemental information.

9. The secured electronic device of claim 7, further comprising:
a display that presents content to the user of the secured electronic device;
an inward facing image capture device that is collocated with the display on a same surface of the secured electronic device,
wherein in response to the occurrence of the operation that matches the predefined trigger event activity, the inward facing image capture device is operated to capture the at least one image showing the person.

10. The secured electronic device of claim 9, wherein the at least one image captured by the inward facing image capture device is a first at least one image, and wherein the secured electronic device further comprises:
an outward facing image capture device that faces outward in an opposing direction to the inward facing image capture device,
wherein in response to the occurrence of the operation that matches the predefined trigger event activity, the outward facing image capture device is operated to capture a second at least one image showing an environment around the secured electronic device.

11. The secured electronic device of claim 7,
wherein the secured electronic device is controllably coupled to a remote image capture device,
wherein in response to the occurrence of the operation that matches the predefined trigger event activity, the remote image capture device is operated to capture the at least one first image.

12. The secured electronic device of claim 7, further comprising:
a microphone that acquires an audio clip of a predefined duration in response to the occurrence of the operation that matches the predefined trigger event activity,
wherein the supplemental information acquisition logic includes an audio clip in the supplemental information.

13. The secured electronic device of claim 7, further comprising:
an internal device that sense movement of the secured electronic device after some predefined duration wherein the secured electronic device has remained motionless,
wherein in response to sensing the movement of the secured electronic device, the trigger management logic determines the occurrence of the operation that matches the predefined trigger event activity.

14. The secured electronic device of claim 7, further comprising:
an external device interface that communicatively couples the secured electronic device to a user interface device that receives user input from the user interface to control the secured electronic device,
wherein in response to receiving a predefined user input to control the secured electronic device, the trigger management logic determines the occurrence of the operation that matches the predefined trigger event activity.

15. The secured electronic device of claim 7, wherein the secured electronic device is a smart phone.

16. A method of monitoring use of a secured electronic device, comprising:
monitoring an operation of the secured electronic device;
comparing, at the secured electronic device, the monitored operation with a plurality of predefined trigger event activities stored in a trigger event database;
generating, at the secured electronic device, a trigger in response to the monitored operation matching one of the predefined trigger event activities, wherein the trigger causes an image capture device to acquire at least one image that includes an image of a person using the secured electronic device during the occurrence of the trigger event activity;
acquiring, at the secured electronic device, supplemental information comprising at least information that identifies the secured electronic device and a time of occurrence of the operation that matches the predefined trigger event activity;
associating, at the secured electronic device, the at least one image and the supplemental information; and
communicating the at least one image and the supplemental information from the secured electronic device onto a communication network for storage in a data storage system.

17. The method of claim 16, further comprising:
receiving the communicated at least one image and the supplemental information at an information management and user interface system;
storing the received at least one image and the supplemental information in a data storage system, wherein a storage location information indicating where the received at least one image and the supplemental information is stored in the data storage system is determined; and
storing the determined storage location information at the information management and user interface system.

18. The method of claim 17, further comprising:
receiving, at the information management and user interface system, a user request from the secured electronic device, wherein the user request that includes identification information that identifies the secured electronic device, information identifying at least a time of interest, and information identifying the secured electronic device as the recipient of the stored at least one image;
retrieving, at the information management and user interface system, the storage location information corresponding to the supplemental information in the received user request;
retrieving the at least one image and the supplemental information from the data storage system based on the retrieved storage location; and
communicating the retrieved at least one image and the supplemental information to the secured electronic device.

19. The method of claim 17, wherein the secured electronic device is a first secured electronic device, and further comprising:
receiving, at the information management and user interface system, a user request from a second secured electronic device, wherein the user request that includes identification information that identifies the first secured electronic device, information identifying at least a time of interest, and information identifying the second secured electronic device as the recipient of the stored at least one image;
retrieving, at the information management and user interface system, the storage location information corresponding to the supplemental information in the received user request;
retrieving the at least one image and the supplemental information from the data storage system based on the retrieved storage location; and
communicating the retrieved at least one image and the supplemental information to the second secured electronic device.

20. The method of claim 17, wherein the image capture device that acquires the at least one image during the occurrence of the trigger event activity is a component of the secured electronic device.
